(19) United States
(12) Patent Application Publication
(10) Pub. No.: US 2013/0218525 A1
(43) Pub. Date: Aug. 22, 2013

(54) Methods and Systems for Generating and Editing Surfaces

(71) Applicant: Grocker Gary, San Diego, CA (US)

(72) Inventor: Grocker Gary, San Diego, CA (US)

(73) Assignee: IntegrityWare, Inc., San Diego, CA (US)

(21) Appl. No.: 13/398,701

(22) Filed: Feb. 16, 2012

(51) Int. Cl. G06F 17/50

(52) U.S. Cl. 703/1

(57) ABSTRACT

Methods and systems for generating surface data from polygonal data are disclosed. The methods and systems receive polygonal data which describe discrete points on an object. The methods and systems analyze and use the data to calculate and define a continuous BREP object which accurately represents the original polygonal object. In some embodiments, the BREP object is modified and certain details of the modification operations are recorded. The polygonal data may be edited and a new BREP object created based on the edited polygonal data. The new BREP object may be automatically modified by automatically reperforming the recorded modification operations.

### BACKGROUND

1. Field

The described technology relates to systems and methods of generating geometric models based on a geometric object and a reference geometry.

2. Description of the Related Technology

Polygonal model data is created with, for example, a 3-D CAD software tool by, for example, a designer. The polygonal model or polygonal mesh includes discrete data points describing one or more surfaces or objects. Polygonal models are convenient for design work at least because they define the surface or object with a degree of detail convenient for the designer to work with. The shape of the surface or object is defined by the data points, and the surface between the data points is perceived, but is not necessarily represented in the data. This allows for the CAD system to function quicker because of a significantly reduced data set representing the surface or object, while providing the designer enough detail to manipulate to achieve a desired design.

The polygonal data may be edited by a designer according to the designer's purposes. For example, the designer may add features to the object represented by the polygonal data using mesh operations. In addition, to create smooth, natural looking objects, a smoothing algorithm may be used to modify the polygonal data. For example, a Catmull-Clark algorithm may be performed on the polygonal data. The smoothing algorithm modifies the polygonal data by, for example, adding vertices and repositioning existing vertices. Thus, the smoothing algorithm generates a modified object.

In some applications, the finished polygonal data object may preferably have a portion thereof having geometric parameters specified by an external predetermined reference object. For example, a polygonal data object, which represents a part of a machine, may be generated. The finished machine part may have a surface which is to mate against another surface or part of the machine. Accordingly, in the process of generating the polygonal data object, a reference object having the characteristics of the other surface or part of the machine may be used to generate the surface of the polygonal data object which will mate to the surface of the machine.

Conventionally, to generate such an object, the Catmull-Clark algorithm is performed on the polygonal data to generate a smooth machine part. Subsequently, the smooth machine part is manually edited by a designer who moves vertices of the smooth machine part to generate the desired surface which conforms to the other machine surface. Such a manual process is time consuming and error prone.

### SUMMARY OF CERTAIN INVENTIVE ASPECTS

Various aspects of certain embodiments of methods and systems for generating smoothed polygonal data having a desired predetermined geometric characteristic are discussed. The methods and systems receive polygonal data which describe discrete points on an object and receive a reference object which describes the desired geometric characteristics of the smoothed polygonal data. The methods and systems smooth the polygonal data and shape the smoothed polygonal data according to the reference object.

### BRIEF DESCRIPTION OF THE DRAWINGS

FIGS. 1A-1H are graphical illustrations of a reference geometry and polygonal data at different points during an embodiment of a method of generating smoothed polygonal data.

FIGS. 2A-2H are graphical illustrations of a reference geometry and polygonal data at different points during another embodiment of a method of generating smoothed polygonal data.

FIGS. 3A-3L are graphical illustrations of a reference geometry and polygonal data at different points during yet another embodiment of a method of generating smoothed polygonal data.

FIGS. 4A-4D are graphical illustrations of a reference geometry and polygonal data at different points during an embodiment of a method of generating smoothed polygonal data.

FIGS. 5A-5H are graphical illustrations of a reference geometry and polygonal data at different points during another embodiment of a method of generating smoothed polygonal data.

FIGS. 6A-6H are graphical illustrations of multiple reference geometries and polygonal data at different points during an embodiment of a method of generating smoothed polygonal data.

FIGS. 7A-7H are graphical illustrations of multiple reference geometries and polygonal data at different points during another embodiment of a method of generating smoothed polygonal data.

FIGS. 8 and 9 are graphical illustrations of a reference geometry and polygonal data at different points during other embodiments of methods of generating smoothed polygonal data.

### DETAILED DESCRIPTION OF CERTAIN INVENTIVE EMBODIMENTS

Various aspects and features of methods and systems are described herein with reference to the accompanying drawings, which show certain exemplary embodiments. The described embodiments may be modified in various ways, without departing from the spirit or scope of the present invention or inventions. In addition, the described embodiments have multiple features and aspects, no single one of which is solely responsible for the desirable characteristics of the embodiments. Furthermore, no single feature or aspect is essential to practicing the methods and systems described herein. Furthermore, various features and aspects of the embodiments may be combined in embodiments not specifically described.

Various inventive aspects of certain embodiments of methods and systems for generating smoothed polygonal data objects having a portion with desired geometric characteristics are discussed. The methods and systems access one or more reference geometries which describe the desired geometric characteristic of the smoothed object and access polygonal data which describe discrete points of a geometric object. The methods and systems use a smoothing algorithm, such as a Catmull-Clark algorithm to smooth the geometric object and use the reference geometry to cause the smoothed polygonal object to have a portion with the desired geometric characteristics.

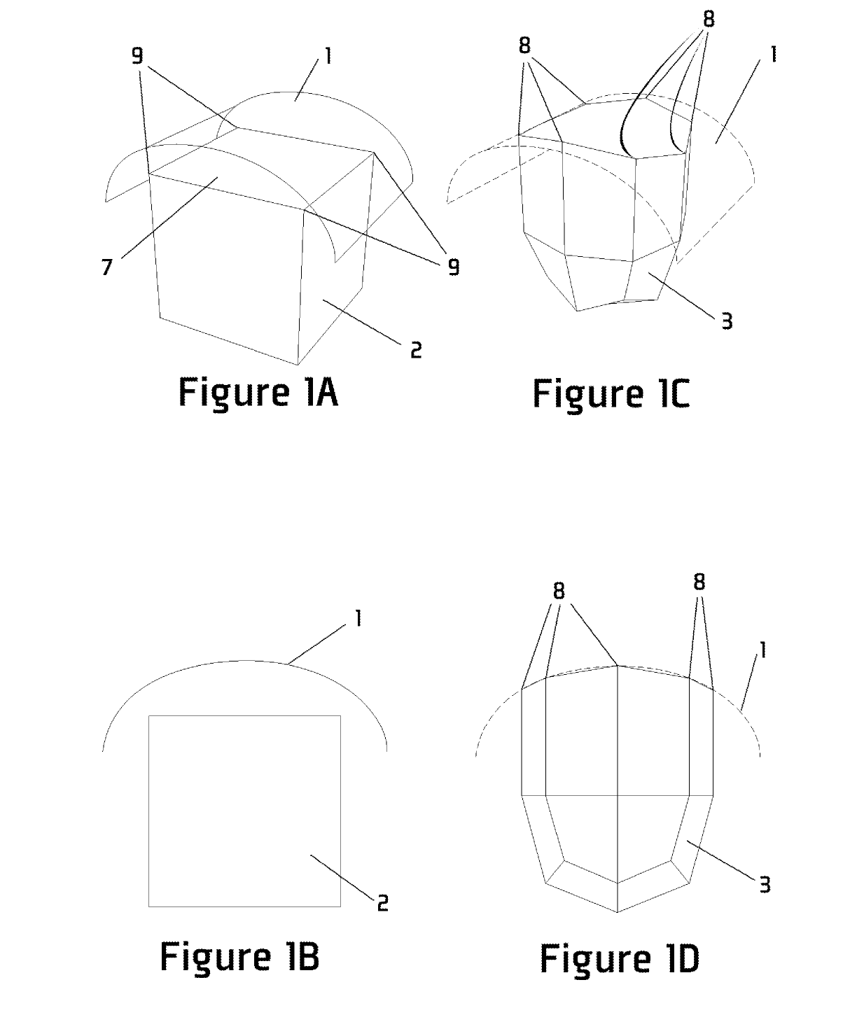

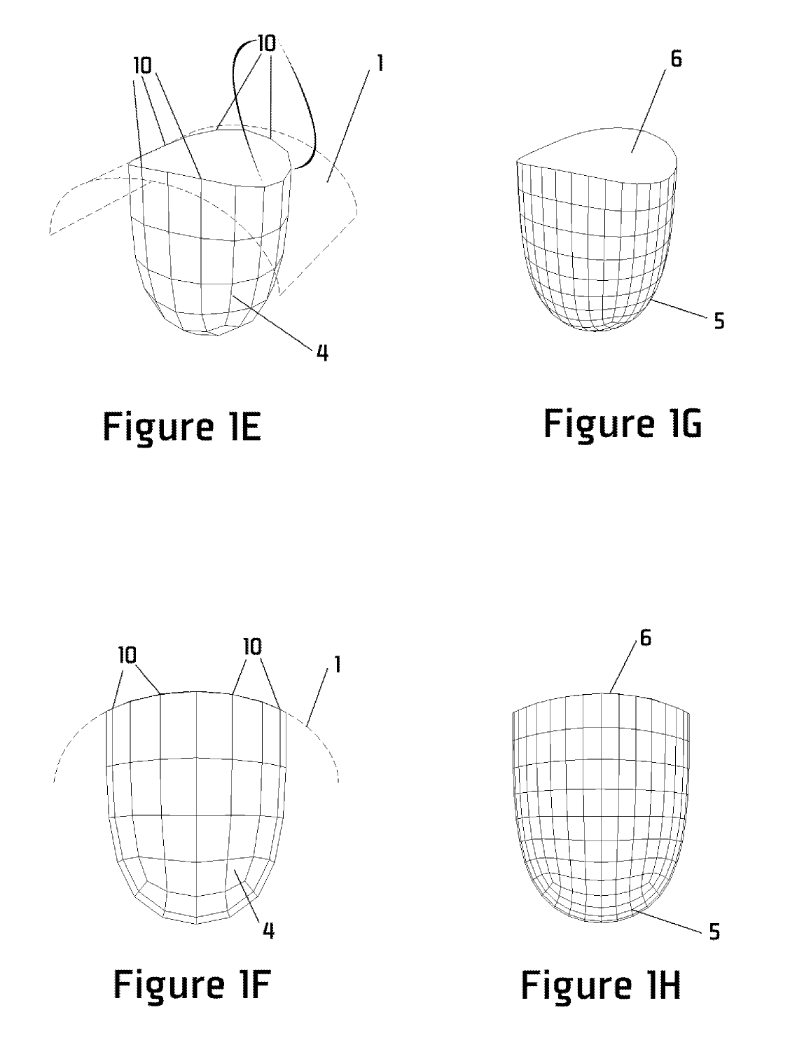

For example, the methods and systems may access electronic data which describes reference object 1 and polygonal data object 2, such as that represented in FIGS. 1A and 1B. In this example the reference object 1 is a surface model. In some embodiments, the reference object is a polygonal model or another type of model. Based on the accessed data, and according to input from a user, the methods and computer systems generate a smoothed polygonal object 5, such as that represented in FIGS. 1G and 1H. Among other beneficial aspects, the smoothed polygonal object 5 has been smoothed according to the smoothing algorithm and represents a surface 6 which has geometric characteristics which are defined by the reference geometry 1. In this example, the surface 6 conforms to the reference geometry 1.

FIGS. 1A-1H are graphical illustrations of the reference geometry 1 and polygonal data 2, 3, 4, and 5 at different points during an embodiment of a method of generating the smoothed polygonal object 5. FIGS. 1A and 1B represent reference object 1 and polygonal data object 2 as accessed and prior to smoothing and conforming.

In some embodiments, prior to the smoothing and conforming operation, using the computer system, a user arranges and orients the polygonal data object 2 and the reference object 1 so as to have a desired spatial relationship. The user also provides an indication to the computer system designating a portion of the polygonal data object 2 as that which is to conform to the reference object 1 during subsequent smoothing and conforming operations. In addition, the user provides an indication as to how the designated portion is to conform to the reference object 1. Various conforming schemes are discussed below. The computer system then records with the data representing the polygonal data object 2, information indicating the designation. For example, the user may indicate that a surface generated based on the top surface 7 of polygonal data object 2 is to conform to the reference object 1. In response to the indication, the computer system may record information for, or “mark”, the top surface 7 which indicates that the surface generated based on surface 7 is to conform to the reference object 1. Similarly, the user may indicate that vertices based on one or more of the vertices 9 defining the top surface 7 are to conform to the reference object 1. In response to the indication, the computer system may record information for, or mark, each of the vertices 9 which indicates that each of the vertices generated based on the vertices 9 is to conform to the reference object 1. Accordingly, the information stored for the marked at least one surface and/or marked one or more vertices can be used as a flag or marker to indicate to the smoothing and conforming algorithm that new geometries created during a smoothing operation based on the marked geometries are to be located according to the reference object 1. In some embodiments, the new geometries created by the smoothing operation inherit the markers from the geometries from which they are created.

FIGS. 1C and 1D show polygonal object 3 after one iteration of smoothing and conforming. As indicated in FIGS. 1C and 1D, the smoothing and conforming has added vertices and located vertices such that polygonal object 3 is smoother and rounder as compared to polygonal data object 2 on which the smoothing and conforming operations were performed. In addition, the smoothing and conforming operations have generated the object 3 having vertices 8, which are on the reference geometry 1.

In some embodiments, a position is determined by a smoothing algorithm for each vertex 8 without regard for the reference geometry 1. Subsequently, each vertex 8 is projected from the position determined by the smoothing algorithm to the reference geometry 1 according to a projection scheme indicated by the user. In this embodiment, the direction for the projection paths is perpendicular to the top surface 7, which is adjacent to the reference geometry 1. Accordingly, the vertices 8 are moved from their positions as determined by the smoothing algorithm to the reference geometry 1 along parallel projection paths. In some embodiments, projection paths are determined using other methods, such as those described below.

In some embodiments, prior to performing the smoothing and conforming algorithm, the computer system moves the marked geometries of the object 2 to the reference geometry 1 along a projection path, for example, such as that described above. In such embodiments, the vertices moved after the smoothing operation are marked new vertices added by the smoothing algorithm.

Other methods of determining projection paths and locations for the moved vertices may be used. For example, using the smoothing and conforming algorithm, the computer system may generate new vertices based on vertices of the polygonal data object 2 which are on the reference geometry 1 such that locations for the new vertices are on the reference geometry 1, and are calculated using a space confined to the reference geometry 1. In such embodiments a smoothing algorithm does not determine a position for each new vertex which is subsequently modified according to a projection path, but instead, the computer system calculates the position for each new vertex directly from the positions of the previously generated vertices and the space defined by and limited to the reference geometry 1.

FIGS. 1E and 1F show polygonal object 4 after a second iteration of smoothing and conforming. As indicated in FIGS. 1E and 1F, the second iteration of smoothing and conforming has added and moved vertices such that polygonal object 4 is smoother and rounder as compared to polygonal object 3 on which the smoothing and conforming operations were performed. In addition, the smoothing and conforming operations have generated vertices 10 of the object 4 which are on the reference geometry 1. In this embodiment, the projection paths of the moved vertices 10 are parallel to the projection paths of the moved vertices 8 discussed above with reference to FIGS. 1C and 1D. In some embodiments, projection paths of a second iteration of smoothing and conforming may not be parallel to the projection paths of a first iteration of smoothing and conforming. For example, prior to each iteration, the user may provide an indication for the computer system to use another projection path scheme.

FIGS. 1G and 1H show polygonal object 5 after a third iteration of smoothing and conforming. In FIGS. 1G and 1H the reference geometry 1 is not shown. As indicated in FIGS. 1G and 1H, the third iteration of smoothing and conforming has added vertices such that polygonal object 5 is smoother and rounder as compared to polygonal object 4 on which the smoothing and conforming operations were performed. In addition, the smoothing and conforming operations have generated vertices which conform to the reference geometry 1. In this embodiment, the projection paths of the moved vertices are parallel to the projection paths of the moved vertices 8 and 10 discussed above with reference to FIGS. 1C and 1D and FIGS. 1E and 1F. As indicated in FIGS. 1G and 1H, the polygonal object 5 is much smoother than the original polygonal object 2 and defines a surface 6 which conforms to the reference geometry 1.

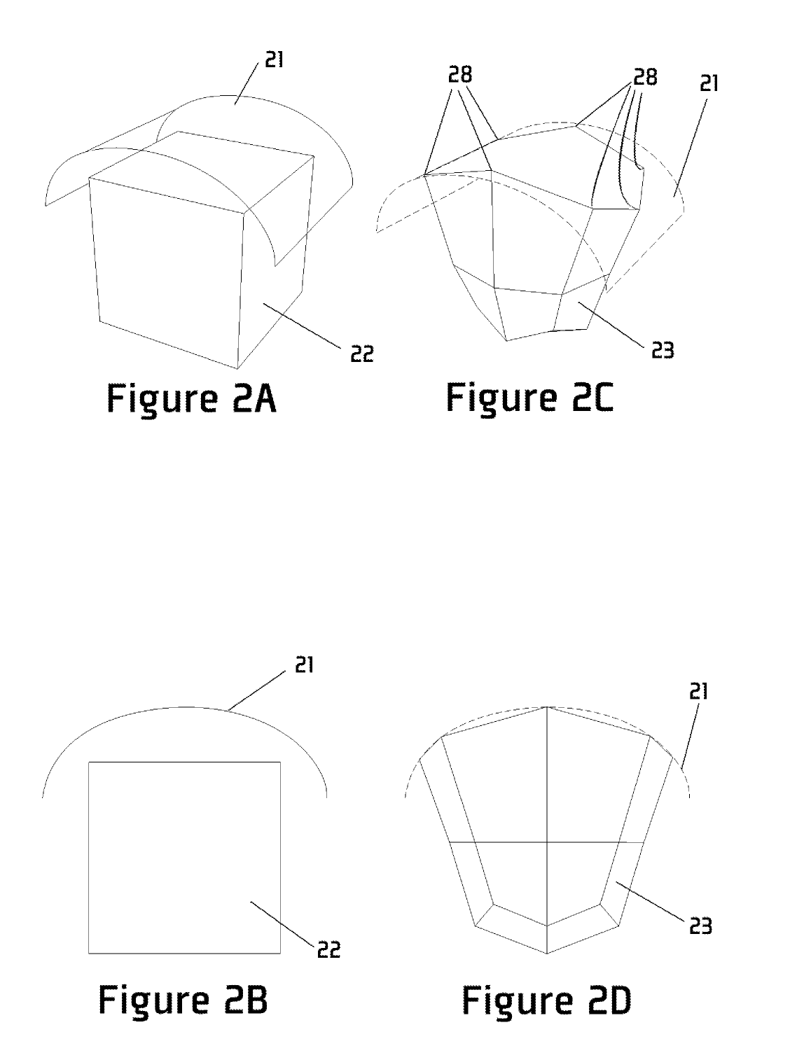

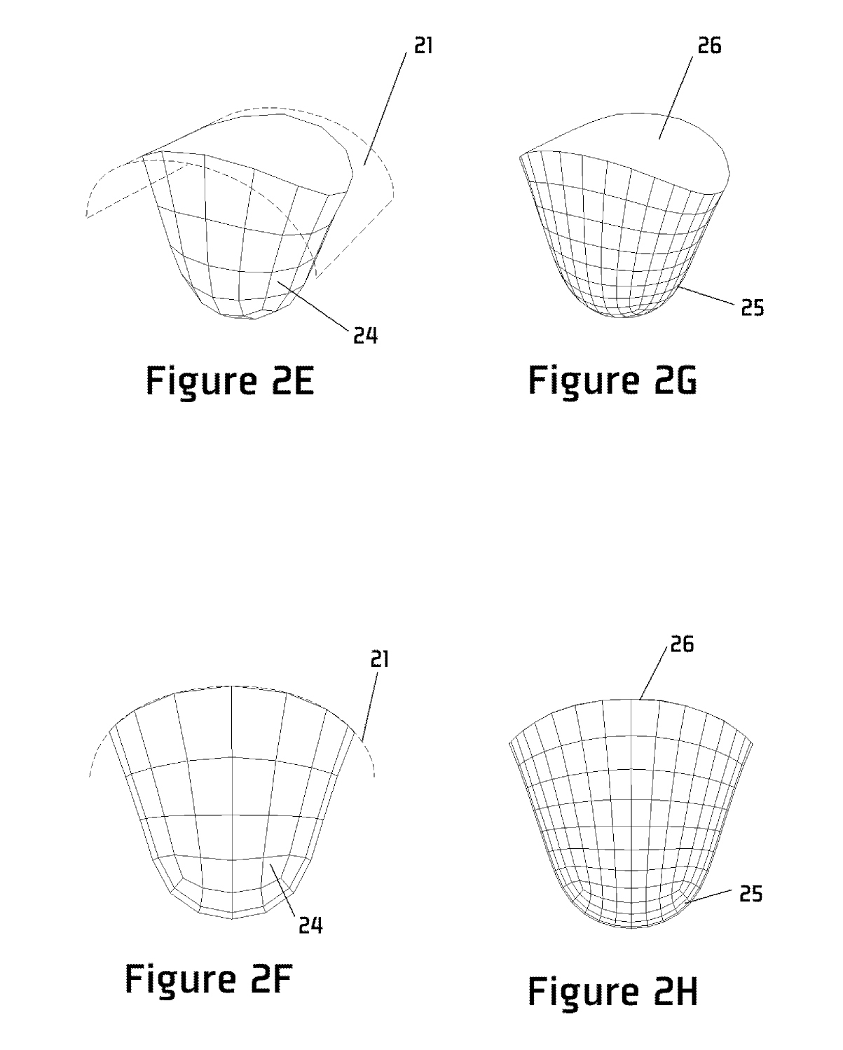

FIGS. 2A-2H are graphical illustrations of the reference geometry 21 and polygonal data 22, 23, 24, and 25 at different points during an embodiment of a method of generating the smoothed polygonal object 25. In this embodiment, smoothing and conforming operations are performed which are similar to the smoothing and conforming operations discussed above with regard to FIGS. 1A-1H. In this embodiment, the projection paths of new vertices which conform to reference geometry 21 are not parallel to one another. Instead, in this embodiment, the projection paths are perpendicular to the reference geometry 21.

FIGS. 2A and 2B represent reference object 21 and polygonal data object 22 as accessed by the computer system and prior to smoothing and conforming. In some embodiments, prior to the smoothing and conforming operation, using the computer system, a user arranges and orients the polygonal data object 22 and the reference object 21 so as to have a desired spatial relationship. The user also provides an indication to the computer system to mark a portion of the polygonal data object 22 as that which is to conform to the reference object 21 during one or more subsequent smoothing and conforming operations. In addition, the user provides an indication as to how the designated portion is to conform to the reference object 21, such as what projection scheme is to be used.

FIGS. 2C and 2D show polygonal object 23 after one iteration of smoothing and conforming. As indicated in FIGS. 2C and 2D, the smoothing and conforming has added vertices and located vertices such that polygonal object 23 is smoother and rounder as compared to polygonal data object 22 on which the smoothing and conforming operations were performed. In addition, the smoothing and conforming operations have generated the object 23 having vertices 28, which are on the reference geometry 21.

In some embodiments, a position is determined by a smoothing algorithm for each vertex 28 without regard for the reference geometry 21. Subsequently, each vertex 28 is projected from the position determined by the smoothing algorithm to the reference geometry 21 according to a projection scheme indicated by the user. In this embodiment, the direction for each of the projection paths is perpendicular to the reference geometry 21. Accordingly, the vertices 28 are moved from their positions determined by the smoothing algorithm to the reference geometry 21 along projection paths which are normal to the reference geometry 21 and intersect the positions determined by the smoothing algorithm and prior to projection.

In some embodiments, prior to performing the smoothing and conforming operation, the computer system moves the marked geometries of the object 22 to the reference geometry 21 along a projection path, for example, such as that described above. In such embodiments, the vertices moved after the smoothing operation are marked new vertices added by the smoothing algorithm.

FIGS. 2E and 2F show polygonal object 24 after a second iteration of smoothing and conforming. As indicated in FIGS. 2E and 2F, the second iteration of smoothing and conforming has added and moved vertices such that polygonal object 24 is smoother and rounder as compared to polygonal object 23 on which the smoothing and conforming operations were performed. In addition, the smoothing and conforming operations have generated vertices of the object 24 which are on the reference geometry 21. In this embodiment, the projection paths of the moved vertices are perpendicular to the reference object 21. In some embodiments, projection paths of a second iteration of smoothing and conforming may not be determined according to the same scheme as the projection paths of a first iteration of smoothing and conforming. For example, prior to each iteration, the user may provide an indication for the computer system to use another projection path scheme.

FIGS. 2G and 2H show polygonal object 25 after a third iteration of smoothing and conforming. In FIGS. 2G and 2H the reference geometry 21 is not shown. As indicated in FIGS. 2G and 2H, the third iteration of smoothing and conforming has added vertices such that polygonal object 25 is smoother and rounder as compared to polygonal object 24 on which the smoothing and conforming operations were performed. In addition, the smoothing and conforming operations have generated vertices which conform to the reference geometry 21. In this embodiment, the projection paths of the moved vertices are determined according to the same scheme as the projection paths of the moved vertices discussed above with reference to FIGS. 2C and 2D and FIGS. 2E and 2F. As indicated in FIGS. 2G and 2H, the polygonal object 25 is much smoother than the original polygonal object 22 and defines a surface 26 which conforms to the reference geometry 21.

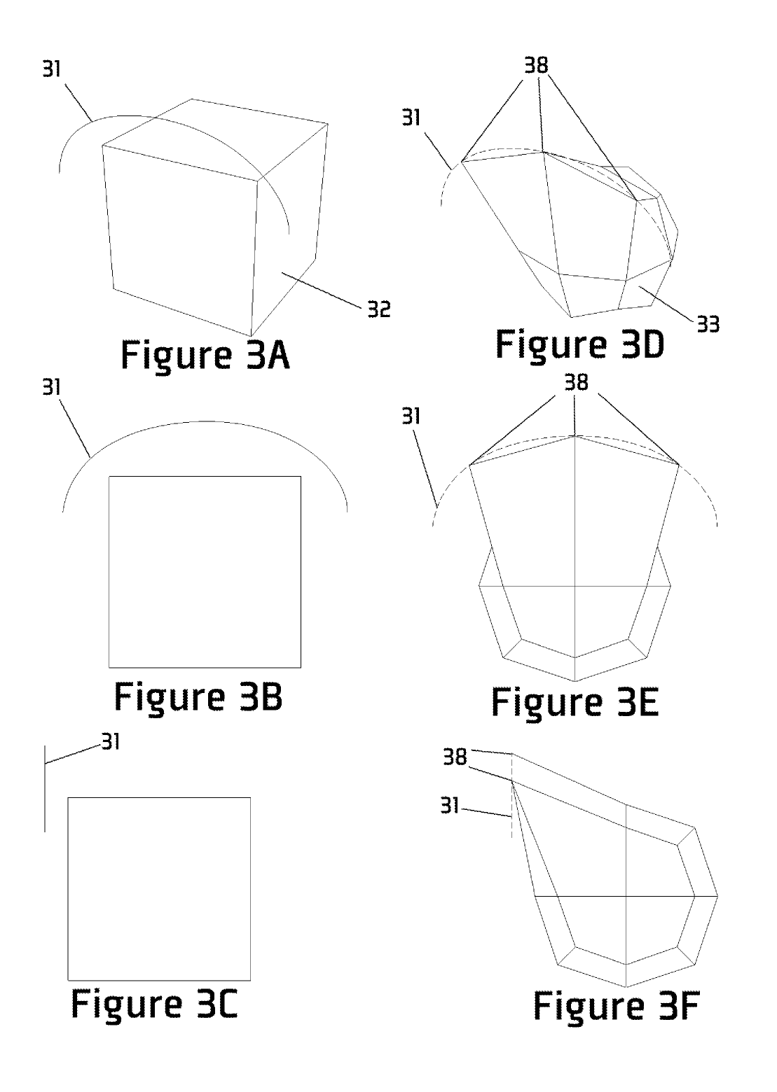

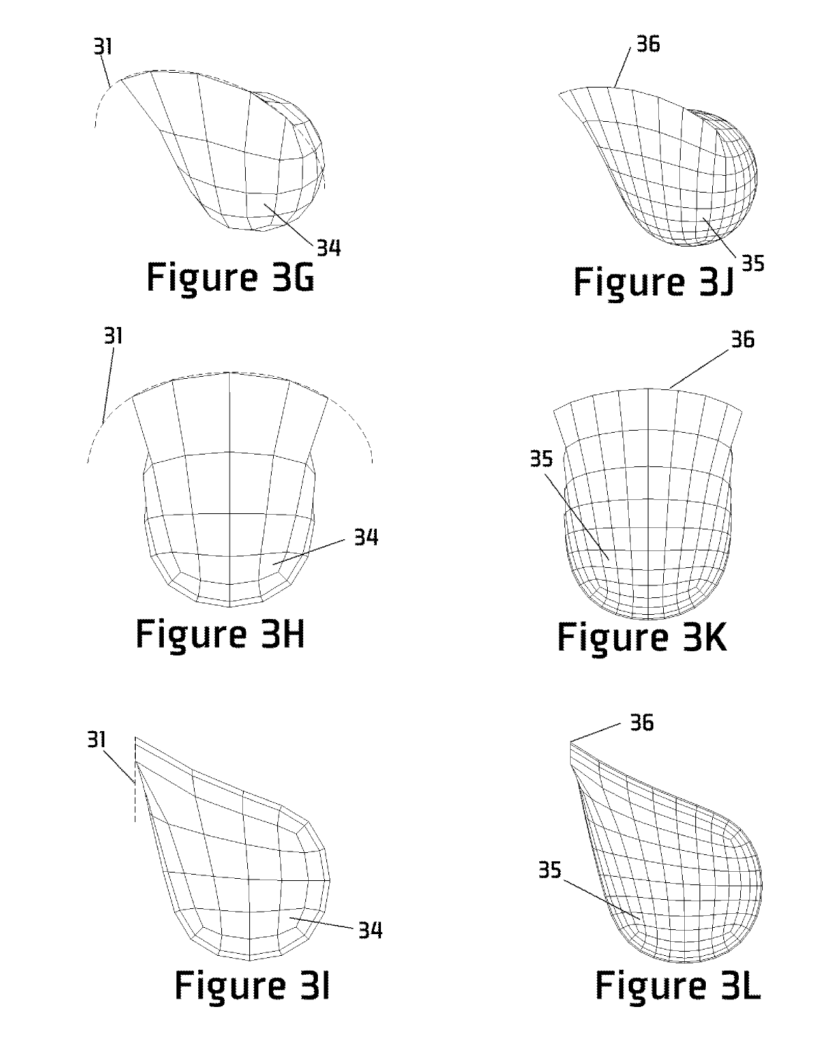

FIGS. 3A-3L are graphical illustrations of a reference geometry 31 and polygonal data 32, 33, 34, and 35 at different points during an embodiment of a method of generating smoothed polygonal data 35. In this embodiment, smoothing and conforming operations are performed which are similar to the smoothing and conforming operations discussed above with regard to FIGS. 1A-1H and 2A-2H. In this embodiment, the reference object or geometry 31 is a curve and the projection paths of new vertices which conform to reference geometry 31 are perpendicular to the reference geometry 31.

FIGS. 3A, 3B, and 3C represent reference object 31 and polygonal data object 32 as accessed by the computer system and prior to smoothing and conforming. In some embodiments, prior to the smoothing and conforming operation, using the computer system, a user arranges and orients the polygonal data object 32 and the reference object 31 so as to have a desired spatial relationship. The user also provides an indication to the computer system to mark a portion of the polygonal data object 32 as that which is to conform to the reference object 31 during subsequent smoothing and conforming operations. In addition, the user provides an indication as to how the designated portion is to conform to the reference object 31, such as what projection scheme is to be used.

FIGS. 3D, 3E, and 3F show polygonal object 33 after one iteration of smoothing and conforming. As shown, the smoothing and conforming has added vertices and located vertices such that polygonal object 33 is smoother and rounder as compared to polygonal data object 32 on which the smoothing and conforming operations were performed. In addition, the smoothing and conforming operations have generated the object 33 having vertices, which are on the reference geometry 31.

In some embodiments, a position is determined by a smoothing algorithm for each vertex without regard for the reference geometry 31. Subsequently, each marked vertex is projected from the position determined by the smoothing algorithm to the reference geometry 31 according to a projection scheme indicated by the user. In this embodiment, the direction for each of the projection paths is perpendicular to the reference geometry curve 31. Accordingly, the vertices 38 are moved from their positions determined by the smoothing algorithm to the reference geometry 31 along projection paths which are normal to the reference geometry 31 and intersect the positions determined by the smoothing algorithm and prior to projection.

FIGS. 3G, 3H, and 3I show polygonal object 34 after a second iteration of smoothing and conforming. As shown, the second iteration of smoothing and conforming has added and moved vertices such that polygonal object 34 is smoother and rounder as compared to polygonal object 33 on which the smoothing and conforming operations were performed. In addition, the smoothing and conforming operations have generated vertices of the object 34 which are on the reference geometry curve 31. In this embodiment, the projection paths of the moved vertices are perpendicular to the reference object 31.

FIGS. 3J, 3K, and 3L show polygonal object 35 after a third iteration of smoothing and conforming. As shown, the third iteration of smoothing and conforming has added vertices such that polygonal object 35 is smoother and rounder as compared to polygonal object 34 on which the smoothing and conforming operations were performed. In addition, the smoothing and conforming operations have generated vertices which conform to the reference geometry 31. In this embodiment, the projection paths of the moved vertices are determined according to the same scheme as the projection paths of the moved vertices discussed above with reference to FIGS. 3D, 3E, and 3F and FIGS. 3G, 3G, and 3I. As shown, the polygonal object 35 is much smoother than the original polygonal object 32 and defines a curve 36 which conforms to the reference geometry curve 31.

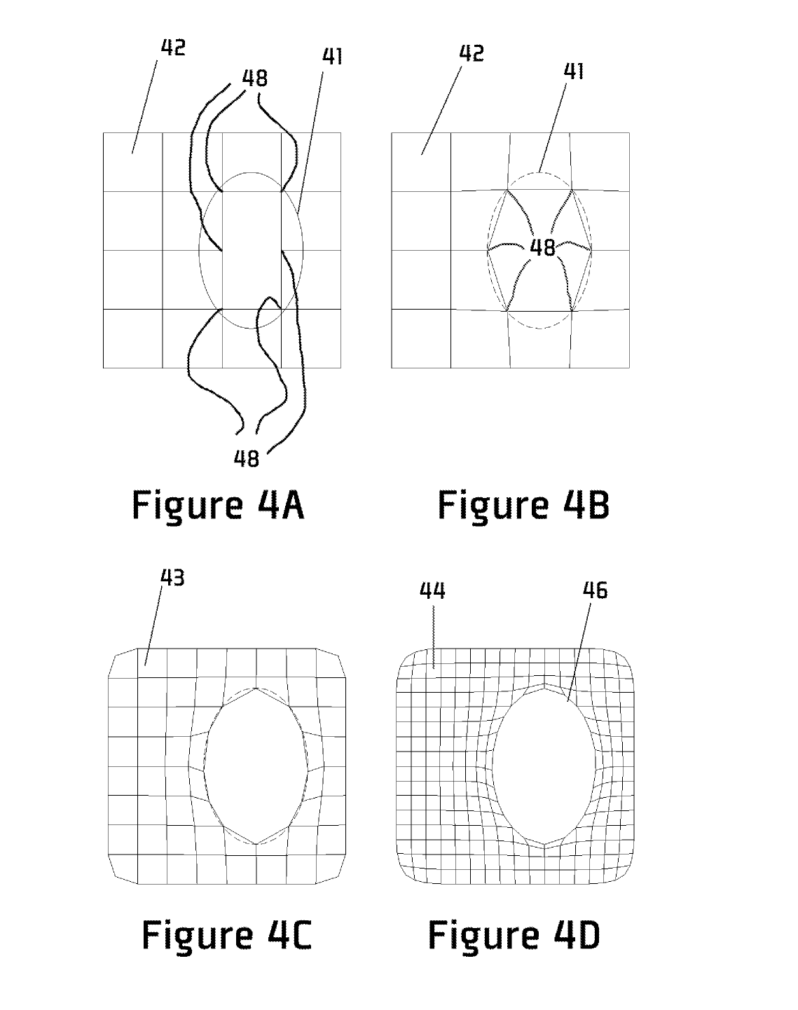

FIGS. 4A-4D are graphical illustrations of a reference geometry 41 and polygonal data 42, 43, 44, and 45 at different points during an embodiment of a method of generating smoothed polygonal data 45. In this embodiment, smoothing and conforming operations are performed which are similar to the smoothing and conforming operations discussed above. In this embodiment, the polygonal data defines a surface, the reference object or geometry 41 is a curve and the projection paths of new vertices which conform to reference geometry 41 are perpendicular to the reference geometry 41.

FIG. 4A represents reference object 41 and polygonal data object 42 as accessed by the computer system and prior to smoothing and conforming. In some embodiments, prior to the smoothing and conforming operation, using the computer system, a user arranges and orients the polygonal data object 42 and the reference object 41 so as to have a desired spatial relationship. The user also provides an indication to the computer system to mark a portion of the polygonal data object 42 as that which is to conform to the reference object 41 during subsequent smoothing and conforming operations. In this embodiment, vertices 48 are marked. In addition, the user provides an indication as to how the designated portion is to conform to the reference object 41, such as what projection scheme is to be used.

FIG. 4B shows polygonal object 42 prior to a smoothing operation. In response to an indication from the user, the computer system moves the vertices 48 to conform to the reference object 41 according to a projection path. As shown, each of the vertices 48 has been moved so as to be on the reference object 41. The point on the reference object for each of the vertices 48 corresponds to the point as determined by the computer system according to the projection path scheme selected or input by the user. In this embodiment, each of the vertices 48 is moved to a nearest point on the reference object 41.

Other projection path schemes may be used. For example, in some embodiments, the user indicates a location of a central point and the data describing one or more vertices includes the location of the central point. Projection paths for the vertices having the central point are determined to be along a line from the central point through the position of the vertex prior to being moved. In some embodiments, one or more marked vertices have projection path schemes which are different from a projection path scheme of one or more other vertices.

In some embodiments, a position is determined by a smoothing algorithm for each vertex without regard for the reference geometry 41. Subsequently, each marked vertex is projected from the position determined by the smoothing algorithm to the reference geometry 41 according to the projection scheme indicated by the user. In this embodiment, the direction for each of the projection paths is toward the nearest point on the reference geometry 41.

FIG. 4C shows polygonal object 43 after a first iteration of smoothing and conforming. As shown, the first iteration of smoothing and conforming has added and moved vertices such that polygonal object 43 is smoother and rounder as compared to polygonal object 42 on which the smoothing and conforming operations were performed. In addition, the smoothing and conforming operations have generated vertices of the object 43 which are on the reference geometry curve 41. In this embodiment, the projection paths of the marked vertices are along a line from the point determined for each vertex by the smoothing operation toward a nearest point on the reference geometry 41.

FIG. 4D shows polygonal object 44 after a second iteration of smoothing and conforming. As shown, the second iteration of smoothing and conforming has added vertices such that polygonal object 44 is smoother and rounder as compared to polygonal object 43 on which the smoothing and conforming operations were performed. In addition, the smoothing and conforming operations have generated vertices which conform to the reference geometry 41. In this embodiment, the projection paths of the moved vertices are determined according to the same scheme as the projection paths of the moved vertices discussed above with reference to FIGS. 4B and 4C. As shown, the polygonal object 44 is much smoother than the original polygonal object 42 and defines a curve 46 which conforms to the reference geometry curve 41.

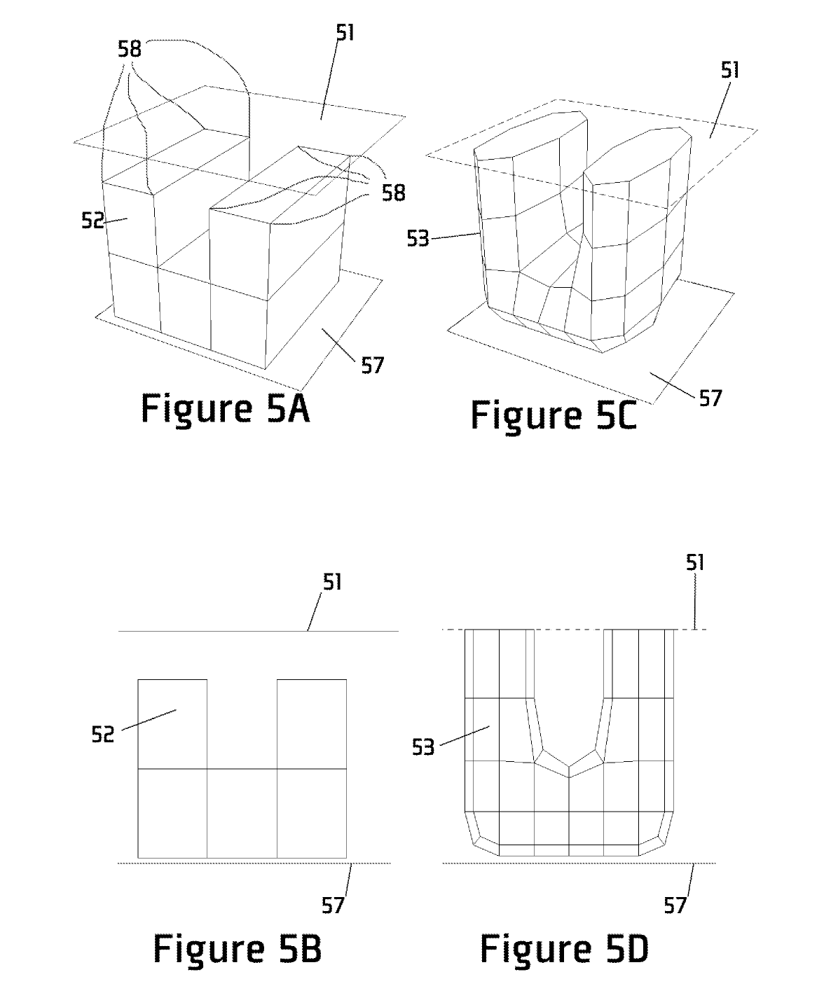

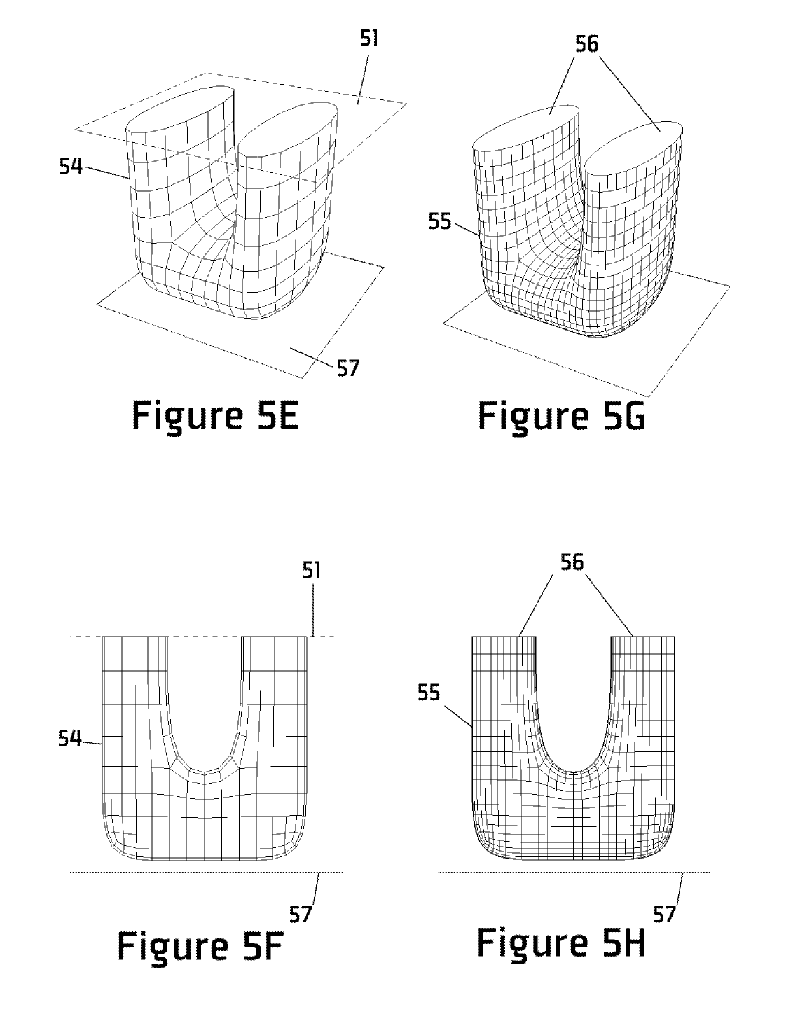

FIGS. 5A-5H are graphical illustrations of a reference geometry 51, polygonal data 52, 53, 54, and 55, and projection geometry 57 at different points during an embodiment of a method of generating smoothed polygonal data 55. In this embodiment, smoothing and conforming operations are performed which are similar to the smoothing and conforming operations discussed above. In this embodiment, the reference object or geometry 51 is a plane, and the projection paths of new vertices which conform to reference geometry 51 are determined with the projection geometry 57. In this embodiment, the projection path for each vertex is along a path including a point on the projection geometry 57 nearest the point for the vertex determined by the smoothing algorithm, and the point determined by the smoothing algorithm. In this embodiment the projection geometry 57 is a plane. In some embodiments the projection geometry is curved, is spherical, or is another shape. In some embodiments, multiple projection geometries 57 may be used. For example, the user may cause the computer system to add a first projection geometry and may provide an indication to the computer system to determine projection paths for a selected subset of the vertices 58 based on the first projection geometry. Similarly, the user may cause the computer system to add a second projection geometry and may provide an indication to the computer system to determine projection paths for a selected subset of the vertices 58 based on the second projection geometry.

FIGS. 5A and 5B represent reference object 51, projection geometry 57, and polygonal data object 52 as accessed by the computer system and prior to smoothing and conforming. In some embodiments, prior to the smoothing and conforming operation, using the computer system, a user arranges and orients the polygonal data object 52, projection geometry 57, and the reference object 51 so as to have a desired spatial relationship. The user also provides an indication to the computer system to mark a portion of the polygonal data object 52 as that which is to conform to the reference object 51 during subsequent smoothing and conforming operations. In this embodiment, vertices 58 are marked. In addition, the user provides an indication as to how the designated portion is to conform to the reference object 51, such as what projection scheme is to be used and what projection geometries are to be used.

FIGS. 5C and 5D show polygonal object 53 after one iteration of smoothing and conforming. As shown, the smoothing and conforming has added vertices and located vertices such that polygonal object 53 is smoother and rounder as compared to polygonal data object 52 on which the smoothing and conforming operations were performed. In addition, the smoothing and conforming operations have generated the object 53 having vertices, which are on the reference geometry 51.

In some embodiments, a position is determined by a smoothing algorithm for each vertex without regard for the reference geometry 51. Subsequently, each marked vertex is projected from the position determined by the smoothing algorithm to the reference geometry 51 according to the projection geometry 57. In this embodiment, the direction for each of the projection paths is from a point on the projection geometry nearest each vertex to the pre-moved location of the vertex. Accordingly, the vertices 58 are moved from their positions determined by the smoothing algorithm to the reference geometry 51 along projection paths which are normal to the projection geometry 57 and intersect the positions determined by the smoothing algorithm and prior to projection.

FIGS. 5E and 5F show polygonal object 54 after a second iteration of smoothing and conforming. As shown, the second iteration of smoothing and conforming has added and moved vertices such that polygonal object 54 is smoother and rounder as compared to polygonal object 53 on which the smoothing and conforming operations were performed. In addition, the smoothing and conforming operations have generated vertices of the object 54 which are on the reference geometry 51. In this embodiment, the projection paths of the moved vertices are perpendicular to the projection geometry 57.

FIGS. 5G and 5H show polygonal object 55 after a third iteration of smoothing and conforming. As shown, the third iteration of smoothing and conforming has added vertices such that polygonal object 55 is smoother and rounder as compared to polygonal object 54 on which the smoothing and conforming operations were performed. In addition, the smoothing and conforming operations have generated vertices which conform to the reference geometry 51. In this embodiment, the projection paths of the moved vertices are determined according to the same scheme as the projection paths of the moved vertices discussed above with reference to FIGS. 5C and 5D and FIGS. 5E and 5F. As shown, the polygonal object 55 is much smoother than the original polygonal object 52 and defines two surfaces 56 which conform to the reference geometry 51.

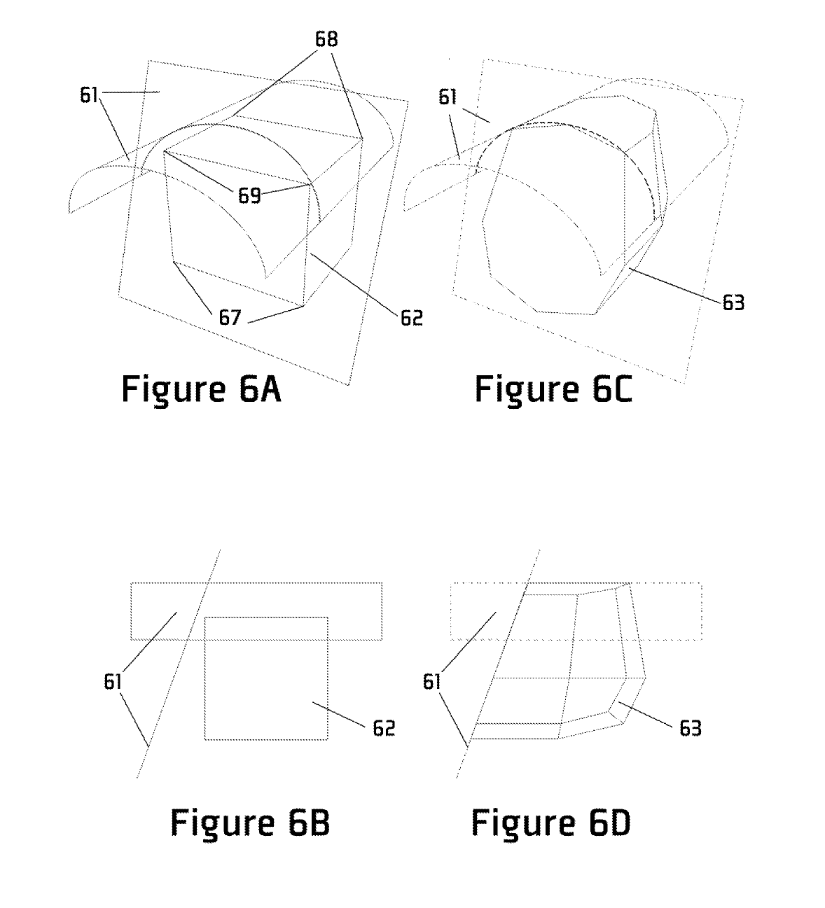

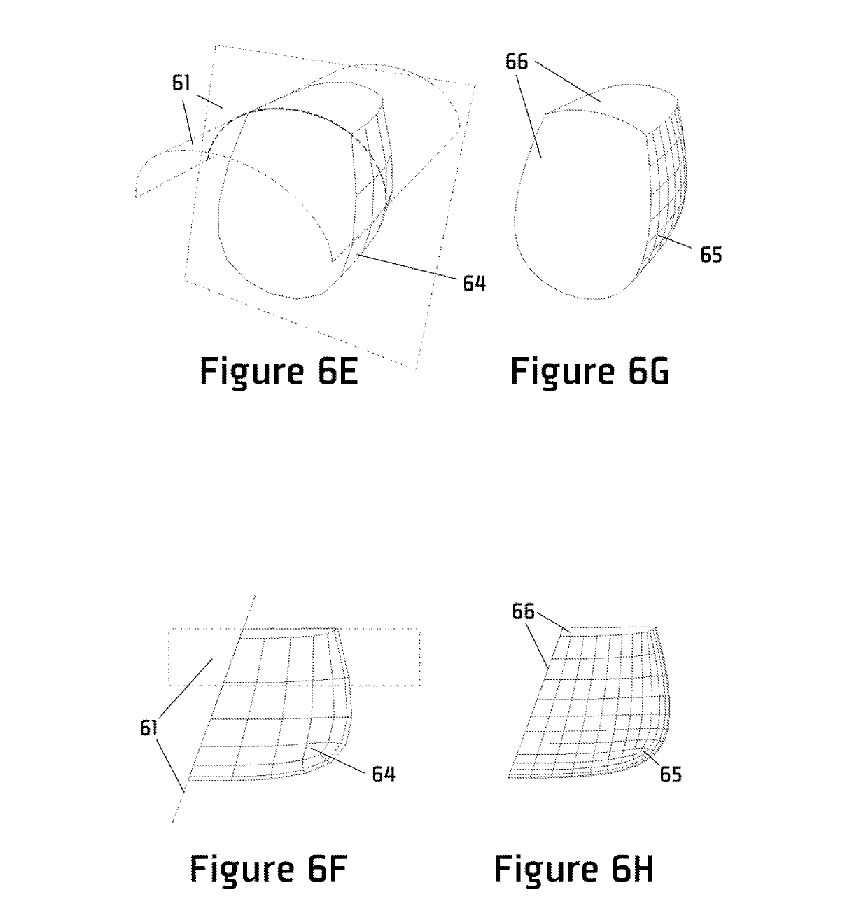

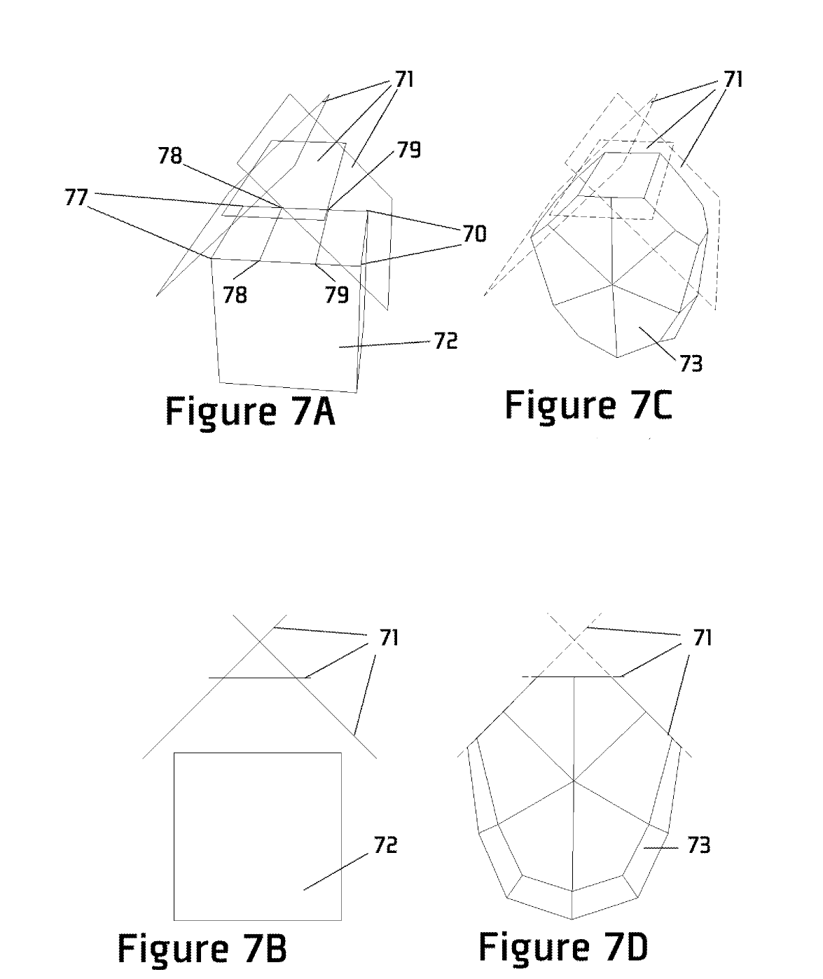

FIGS. 6A-6H are graphical illustrations of multiple reference geometries 61, and polygonal data 62, 63, 64, and 65 at different points during an embodiment of a method of generating smoothed polygonal data 65. In this embodiment, smoothing and conforming operations are performed which are similar to the smoothing and conforming operations discussed above. In this embodiment, the reference objects or geometries 61 include a plane and a concave surface. The projection paths of new vertices which conform to reference geometries 61 may be determined with one or more projection geometries (not shown) or another method.

FIGS. 6A and 6B represent reference objects 61 and polygonal data object 62 as accessed by the computer system and prior to smoothing and conforming. In some embodiments, prior to the smoothing and conforming operation, using the computer system, a user arranges and orients the polygonal data object 62 and the reference objects 61 so as to have a desired spatial relationship. The user also provides an indication to the computer system to mark a portion of the polygonal data object 62 as that which is to conform to the reference objects 61 during subsequent smoothing and conforming operations. In addition, the user provides an indication as to how the designated portion is to conform to the reference object 61, such as what projection scheme is to be used. In some embodiments, the marking operation includes the user providing an indication to the computer system regarding which reference object 61 each marked geometry of the polygonal data object 62 is to conform to. In this embodiment, vertices 67, 68, and 69 are marked. Vertices 67 are marked as being assigned to conform to the plane reference object 61. Vertices 68 are marked as being assigned to conform to the concave surface reference object 61. Vertices 69 are marked as being assigned to conform to both the plane reference object 61 and to the concave surface reference object 61.

FIGS. 6C and 6D show polygonal object 63 after one iteration of smoothing and conforming. As shown, the smoothing and conforming has added vertices and located vertices such that polygonal object 63 is smoother and rounder as compared to polygonal data object 62 on which the smoothing and conforming operations were performed. In addition, the smoothing and conforming operations have generated the object 63 having vertices, which are on the reference geometries 61 according to the assignments discussed above.

In some embodiments, a position is determined by a smoothing algorithm for each vertex without regard for the reference geometry 61. Subsequently, each marked vertex is projected from the position determined by the smoothing algorithm to the reference geometry 61, according to, for example, a method described above. Other methods may be used.

FIGS. 6E and 6F show polygonal object 64 after a second iteration of smoothing and conforming. As shown, the second iteration of smoothing and conforming has added and moved vertices such that polygonal object 64 is smoother and rounder as compared to polygonal object 63 on which the smoothing and conforming operations were performed. In addition, the smoothing and conforming operations have generated vertices of the object 64 which are on the reference geometries 61.

FIGS. 6G and 6H show polygonal object 65 after a third iteration of smoothing and conforming. As shown, the third iteration of smoothing and conforming has added vertices such that polygonal object 65 is smoother and rounder as compared to polygonal object 64 on which the smoothing and conforming operations were performed. In addition, the smoothing and conforming operations have generated vertices which conform to the reference geometries 61. As shown, the polygonal object 65 is much smoother than the original polygonal object 62 and defines two surfaces 66 which conform to the reference geometries 61.

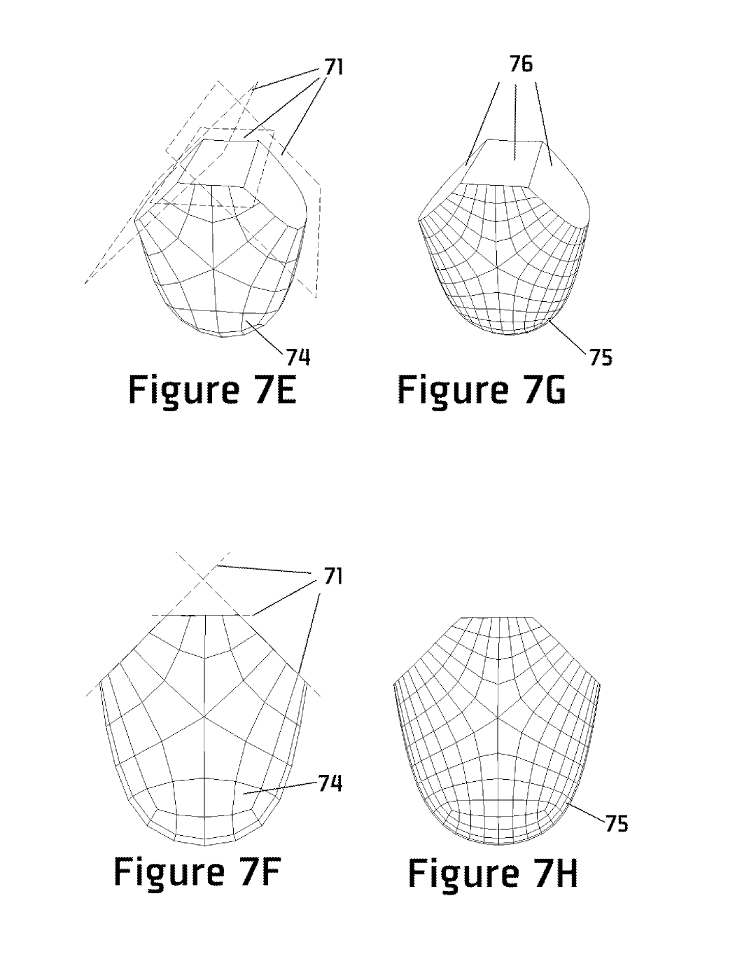

FIGS. 7A-7H are graphical illustrations of multiple reference geometries 71, and polygonal data 72, 73, 74, and 75 at different points during an embodiment of a method of generating smoothed polygonal data 75. In this embodiment, smoothing and conforming operations are performed which are similar to the smoothing and conforming operations discussed above. In this embodiment, the reference objects or geometries 71 include three planes. The projection paths of new vertices which conform to reference geometries 71 may be determined with one or more projection geometries (not shown) or another method.

FIGS. 7A and 7B represent reference objects 71 and polygonal data object 72 as accessed by the computer system and prior to smoothing and conforming. In some embodiments, prior to the smoothing and conforming operation, using the computer system, a user arranges and orients the polygonal data object 72 and the reference objects 71 so as to have a desired spatial relationship. The user also provides an indication to the computer system to mark a portion of the polygonal data object 72 as that which is to conform to the reference objects 71 during subsequent smoothing and conforming operations. In addition, the user provides an indication as to how the designated portion is to conform to the reference object 71, such as what projection scheme is to be used. In some embodiments, the marking operation includes the user providing an indication to the computer system regarding which reference object 71 each marked geometry of the polygonal data object 72 is to conform to. In this embodiment, vertices 70, 77, 78, and 79 are marked. Vertices 70 are marked as being assigned to conform to the reference object 71 on the right of polygonal data object 72. Vertices 77 are marked as being assigned to conform to the reference object 71 on the left of polygonal data object 72. Vertices 78 are marked as being assigned to conform to the reference object 71 on the left of polygonal data object 72 and to the reference object 71 above polygonal data object 72. Vertices 79 are marked as being assigned to conform to the reference object 71 on the right of polygonal data object 72 and to the reference object 71 above polygonal data object 72.

FIGS. 7C and 7D show polygonal object 73 after one iteration of smoothing and conforming. As shown, the smoothing and conforming has added vertices and located vertices such that polygonal object 73 is smoother and rounder as compared to polygonal data object 72 on which the smoothing and conforming operations were performed. In addition, the smoothing and conforming operations have generated the object 73 having vertices, which are on the reference geometries 71 according to the assignments discussed above.

In some embodiments, a position is determined by a smoothing algorithm for each vertex without regard for the reference geometry 71. Subsequently, each marked vertex is projected from the position determined by the smoothing algorithm to the reference geometry 71, according to, for example, a method described above. Other methods may be used.

FIGS. 7E and 7F show polygonal object 74 after a second iteration of smoothing and conforming. As shown, the second iteration of smoothing and conforming has added and moved vertices such that polygonal object 74 is smoother and rounder as compared to polygonal object 73 on which the smoothing and conforming operations were performed. In addition, the smoothing and conforming operations have generated vertices of the object 74 which are on the reference geometries 71.

FIGS. 7G and 7H show polygonal object 75 after a third iteration of smoothing and conforming. As shown, the third iteration of smoothing and conforming has added vertices such that polygonal object 75 is smoother and rounder as compared to polygonal object 74 on which the smoothing and conforming operations were performed. In addition, the smoothing and conforming operations have generated vertices which conform to the reference geometries 71. As shown, the polygonal object 75 is much smoother than the original polygonal object 72 and defines three surfaces 76 which conform to the reference geometries 71.

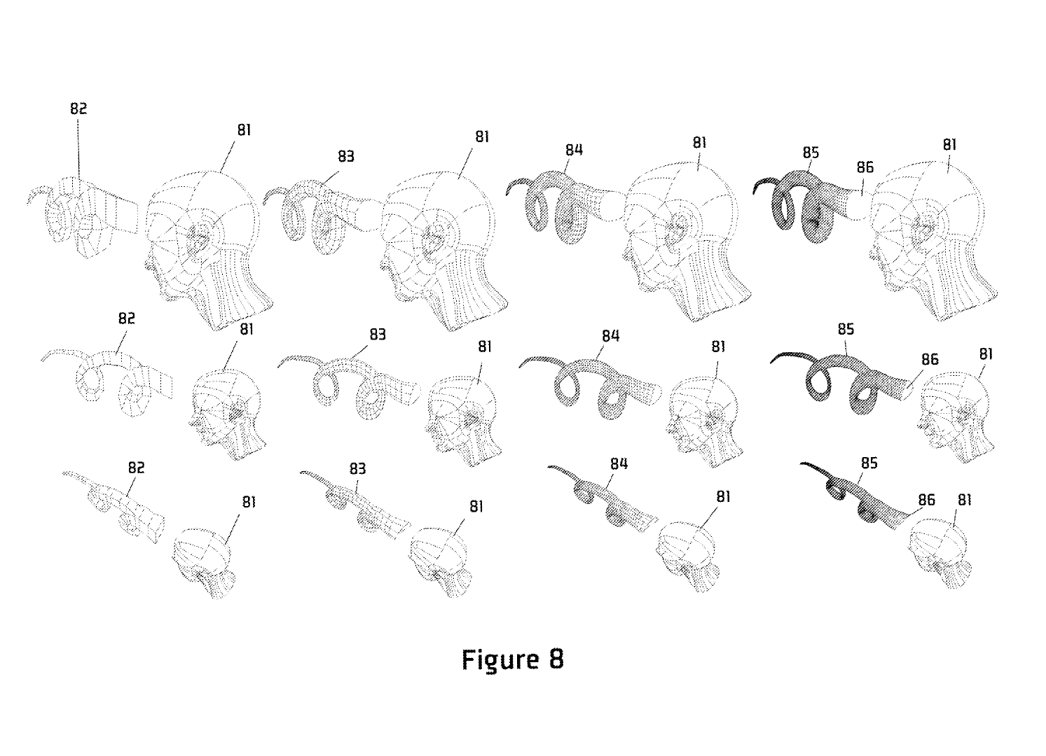

FIG. 8 shows graphical illustrations of a reference geometry 81, and polygonal data 82, 83, 84, and 85 at different points during an embodiment of a method of generating smoothed polygonal data 85. In this embodiment, smoothing and conforming operations are performed which are similar to the smoothing and conforming operations discussed above. In this embodiment, the reference geometry 81 is a surface model of a human head and the polygonal data undergoing smoothing and conforming operations represents a stylized horn. As shown, after the polygonal data has undergone the smoothing and conforming operations, it has a surface 86 which conforms to the surface model of the human head.

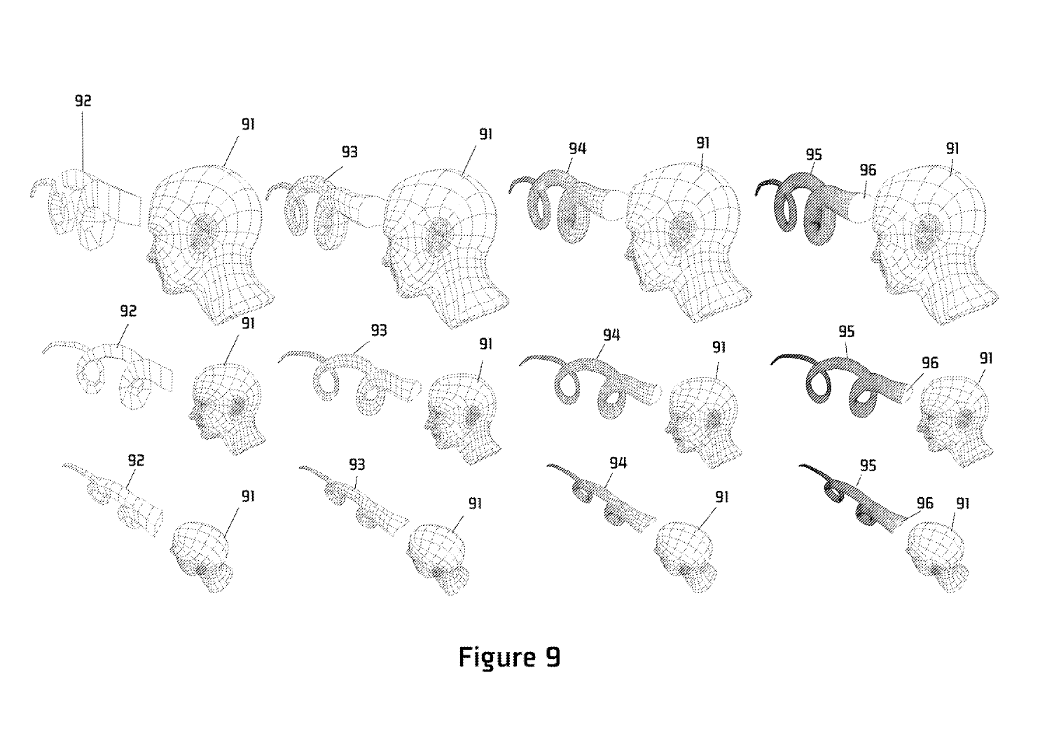

FIG. 9 is graphical illustrations of a reference geometry 81, and polygonal data 92, 93, 94, and 95 at different points during an embodiment of a method of generating smoothed polygonal data 95. In this embodiment, smoothing and conforming operations are performed which are similar to the smoothing and conforming operations discussed above. In this embodiment, the reference geometry 91 is a polygonal model of a human head and the polygonal data undergoing smoothing and conforming operations represents a stylized horn. As shown, after the polygonal data has undergone the smoothing and conforming operations, it has a surface 96 which conforms to the polygonal model of the human head.

The various aspects, processes, and actions may be performed sequentially or in parallel. For example, a system capable of parallel processing may divide certain procedures among the available processing devices.

While various aspects, processes, actions, and systems have been described as being included in the embodiments discussed, the various aspects, processes, actions, and systems can be practiced with certain modifications. For example, the sequential order of the various aspects, processes, and actions may be modified. In addition, certain aspects, processes, and actions may be omitted, and other aspects, processes, and actions may be added.

What is claimed is:

1. A method of producing BREP data, the method comprising:
accessing electronic data defining a mesh of data points;
generating BREP data based on the mesh;
in response to a command from a user, performing one or more BREP operations on the BREP data;
after performing the BREP operations, in response to a command from the user, performing one or more mesh operations on the data points, whereby modified mesh data is generated;
generating modified BREP data based on the modified mesh data;
in response to a command from the user, programmatically reperforming the one or more BREP operations on the modified BREP data, whereby updated BREP data is generated, wherein the BREP operations are reperformed according to one or more of:
A) a location of a geometric feature of the modified BREP data, and
B) a location of a geometric feature resulting from a reperformed BREP operation;
displaying the updated BREP data on the display; and
storing the updated BREP data in the memory.

2. The method of claim 1, further comprising storing the one or more BREP operations.

3. The method of claim 1, wherein storing the one or more BREP operations comprises storing operation information and storing operand information.

4. The method of claim 3, wherein storing the operation information comprises storing instructions for modifying one or more geometries.

5. The method of claim 1, wherein storing the one or more BREP operations comprises storing an identification of a geometric feature of the BREP data.

6. The method of claim 5, wherein reperforming the BREP operations comprises identifying a geometric feature of the modified BREP data which corresponds to the identification.

7. The method of claim 1, wherein storing the one or more BREP operations comprises storing location information of the BREP operations.

8. The method of claim 6, wherein the location information comprises a plurality of location options for the BREP operations.

9. The method of claim 1, wherein reperforming the BREP operations comprises accessing the stored one or more BREP operations.

10. The method of claim 1, wherein reperforming the BREP operations comprises selecting a location for the reperformed operations from a plurality of selectable recorded location information options for the BREP operations.

11. The method of claim 1, wherein performing the BREP operations comprises performing one or more of extruding a surface, performing a Boolean operation, a sweep, a revolve, and generating a fillet.

12. The method of claim 1, wherein performing the mesh operations comprises performing one or more of an extrude, a bevel, a split face, and a move.

13. A method of producing BREP data, the method comprising:
accessing electronic data defining a mesh of data points;
generating BREP data based on the mesh;
in response to a command from a user, adding a feature to the BREP data;
recording information in related to the added feature and related to adding the feature;
after adding the feature, in response to a command from the user, performing one or more mesh operations on the data points, whereby modified mesh data is generated;
generating modified BREP data based on the modified mesh data;
in response to a command from the user, programmatically regenerating the feature, whereby updated BREP data is generated, wherein the updated BREP data includes the added feature, and a location of the added feature is based on one or more of:
A) a location of a geometric feature of the modified BREP data, and
B) a location of a geometric feature resulting from a regenerated feature;
displaying the updated BREP data on the display; and
storing the updated BREP data in the memory.

14. The method of claim 13, wherein recording the information comprises storing BREP operation and operand information for adding the feature.

15. The method of claim 13, wherein recording the information comprises storing location information of the added the feature.

16. The method of claim 15, wherein the location information comprises a location of the added feature with reference to a geometric feature of the BREP data.

17. The method of claim 16, wherein the location information further comprises a location of the added feature with reference to a general coordinate system.

18. The method of claim 15, wherein the location information comprises a plurality of location options for the added feature.

19. The method of claim 13, wherein regenerating the feature comprises selecting a location for the regenerated feature from a plurality of alternative recorded location information options for the BREP operations.

20. The method of claim 13, wherein regenerating the feature comprises identifying a geometric feature of the modified BREP data which corresponds to a recorded identification of a geometric feature of the BREP data.
